(19) United States
(12) Patent Application Publication
(10) Pub. No.: US 2003/0209637 A1
(43) Pub. Date: Nov. 13, 2003

(54) Rotating electrostatic propulsion system

(76) Inventor: John Quincy St. Clair, San Juan, PR (US)

Correspondence Address: John St. Clair, Hyperspace Research Institute, 52 Kings Court, 4A, San Juan, PR, 00911, US

(21) Appl. No.: 10/142,582

(22) Filed: May 9, 2002

(51) Int. Cl. B64G 1/40; B64G 1/42

(52) U.S. Cl. 244/172

(57) ABSTRACT

This invention relates to a spacecraft propulsion system utilizing thrusters comprised of a motor-driven electrostatically charged cylinder rotating within an electrostatically charged annular ring for the purpose of creating a spacetime curvature stress-energy tension in the horizontal direction. The thrusters are augmented by magnetic vortex generators, either embedded in the cylinders or located above each thruster, for the purpose of increasing the permittivity of space by permeating each thruster with low density hyperspace energy generated by a wormhole created between our space and hyperspace. A combination of three thrusters mounted on the underside of the hull of the spacecraft provide thrust and yaw motion control.

### BRIEF SUMMARY OF THE INVENTION

The invention, which is the object of my present application, is a spacecraft propulsion system which develops a spacetime curvature tension utilizing a combination of a rotating radial electrostatic field and a fixed vertical electrostatic field. The two fields create a stress-energy T^{zr} gradient in the radially direction which is equal to force. The radial field is created on the side of a charged rotating cylinder on the underside of the hull. The vertical field is created by an annular charged ring concentric with the cylinder. Three rotating cylinders are located in a triangle on the bottom of the hull in order to produce a force in any direction in the horizontal plane.

### REFERENCE PAPERS

Gravitation, Wheeler, page 80.

### BACKGROUND OF THE INVENTION

When working with Maxwell's equations in tensor notation, it became apparent that a tensor can change identity depending on what permutation of variables is involved. For example, one single equation can involve both charge density and current density. And all of Maxwell's equations can be reduced to just two equations.

In the tensor equation for momentum, if the lever arm is length then the equation is equal to the flow rate of angular momentum. If the lever arm is time, then you get linear momentum. And if the field rotates with time, then the time rate of change of linear momentum is a force which is the basis for this invention.

Einstein said that mass curves space and space tells mass how to move. In this sense, generalized mass can be mass, electromagnetic fields, charge or angular momentum which create a spacetime curvature that produces a force on the spacecraft.

### SUMMARY OF THE INVENTION

The invention relates to a spacecraft utilizing a rotating electrostatically charged cylinder and a concentric annular charged ring to create a stress-energy spacetime curvature in the horizontal plane on the spacecraft's underside hull. A motor drives the rotating cylinder which extends below the hull. A charged surface produces an electric field in the direction normal to the surface. The vertical and rotating electric fields combine to create a rate of change of linear momentum which creates a horizontal propulsive force on the hull.

### STATEMENT REGARDING FEDERALLY SPONSORED RESEARCH OR DEVELOPMENT

Not Applicable.

### A BRIEF DESCRIPTION OF THE DRAWINGS

FIG. 1. Perspective view of spacecraft hull (A) with the three electrostatically charged rotating cylinders (C) surrounded by their annular charge rings (D) extending down on the underside of the hull (B).

FIG. 2. Perspective view of individual thruster showing rotating cylinder and ring.

FIG. 3. Stress-energy tension created by two electric fields and having units of curvature.

FIG. 4. Cylindrical spacetime coordinates {t, r, θ, Z}.

FIG. 5. Faraday electromagnetic F tensor containing electric fields in the radial and vertical directions.

FIG. 6. Stress-energy tensor T showing it is equal to the product of the two electric fields divided by 4π.

FIG. 7. The tensor equation for flow rate of angular momentum S.

FIG. 8. The units are linear momentum due to the time lever arm.

FIG. 9. The rate of change of linear momentum is the horizontal force produced by the two electric fields.

FIG. 10. The angular momentum flows through an area whose normal vector is in the radial direction.

FIG. 11. Cylinder with only one electrostatically charged segment.

FIG. 12. Annular ring with three individual segments which can be charged separately to create a force in a particular direction.

### DETAILED DESCRIPTION OF THE INVENTION

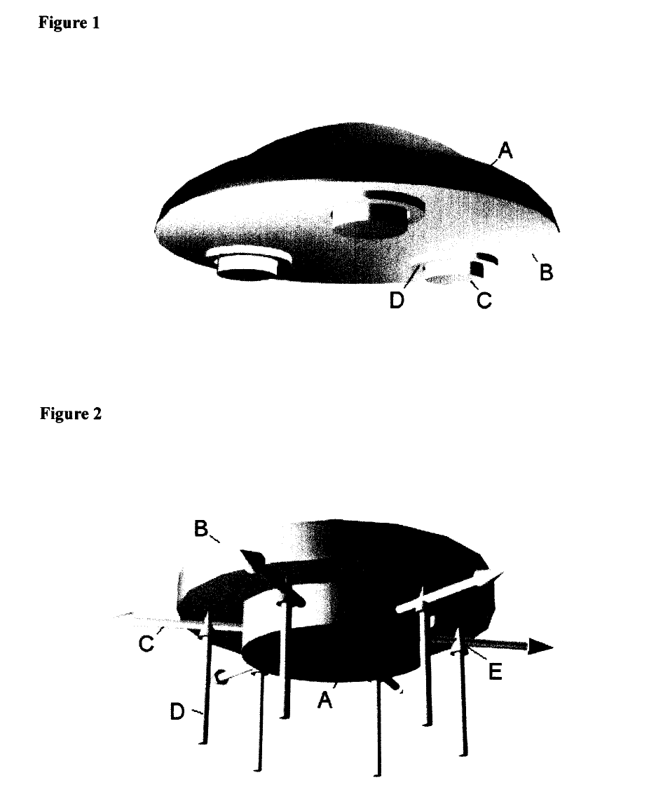

1. Referring to FIG. 1, the spacecraft comprises an upper hull (A) with three rotating electrostatically charged cylinders (C) with their concentric annular electrostatically charged rings (D) located on the spacecraft's bottom hull (B).

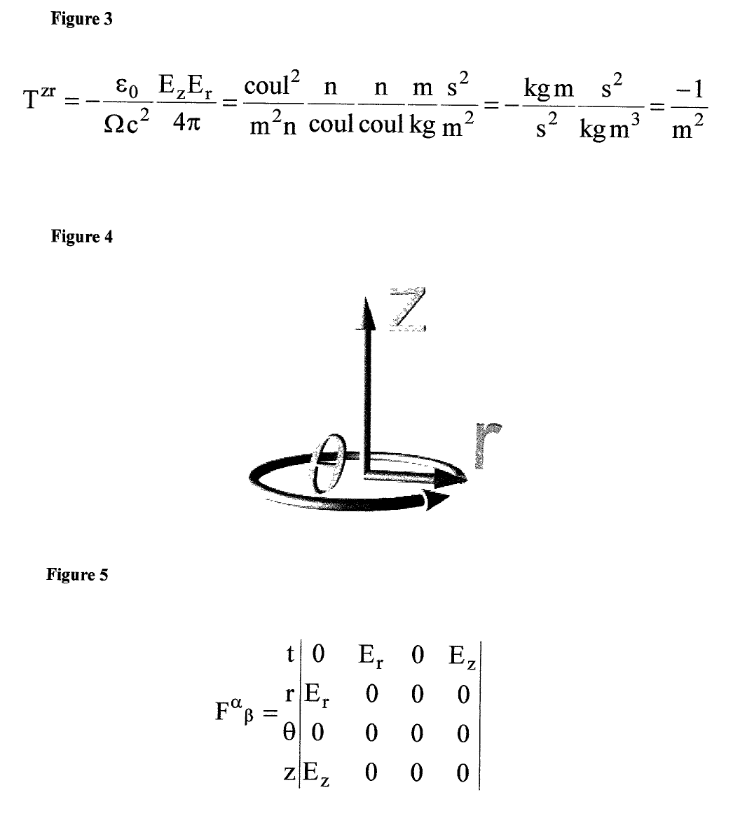

2. In a closer view of one of the cylinders seen in FIG. 2, motor-driven rotating cylinder (A) has an electrostatically charged surface which produces an electric field (C) normal to said surface. The fixed, electrostatically charged annular ring (B), which is concentric with the cylinder, produces a vertical electric field (D) normal to its surface. This crossed field (E) creates a negative spacetime curvature tension which is the product of the two fields divided by 4π as seen in the equation, FIG. 3.

3. Notice that the equation involves the permittivity of space ε₀ divided by the linear mass of the universe Ω and the speed of light. This produces units of inverse meter squared which is the spacetime curvature. In Einstein's General Theory of Relativity, the spacetime curvature tensor is equal to the stress-energy tensor or G=8πT where G is the curvature, and T is the product of the electromagnetic fields. The problem with this equation, which has been resolved with this invention, is that the linear mass Ω times the speed of light c is an enormous number. Even with the square of enormous electric fields, the curvature would be too small even to notice, and little force would be generated.

4. In another patent application of mine entitled Magnetic Vortex Generator, it was shown that a rotating cylinder containing embedded and stacked bar magnets produces a negative mass and negative spacetime spring constant. It can be shown that this combination produces a small wormhole or interdimensional connection between our space and hyperspace along the centerline of the rotating cylinder. Co-dimensions of hyperspace have different physics constants. A low pressure region of hyperspace has a very low mass density and a very low speed of light. The wormhole allows this low density hyperspace energy to enter into our space and permeate the cylinder and annular ring. The permittivity is proportional to the inverse of the speed of light squared. The hyperspace speed of light, obtained from my tetrahedron physics diagram, is 8971 meters per second. The speed of light in our dimension is 299792458 meters per second. As shown by the enclosed reference calculation, the hyperspace permittivity is about a trillion times larger. Because the force is equal to this new permittivity times the electric fields squared times the area around cylinder, the force is greatly amplified by this increase in the permittivity of space.

5. It is pertinent to this invention how the stress-energy is created due to the two electric fields in the vertical and radial direction. In gravitational physics, there is a Faraday F tensor which contains all the components of the electromagnetic fields. It is a 4 by 4 matrix whose rows and columns correspond to the coordinates of spacetime which in cylindrical coordinates are {t, r, θ, z} where t is time, r the radius, theta the horizontal angle and z the vertical height. These coordinates are shown in FIG. 4.

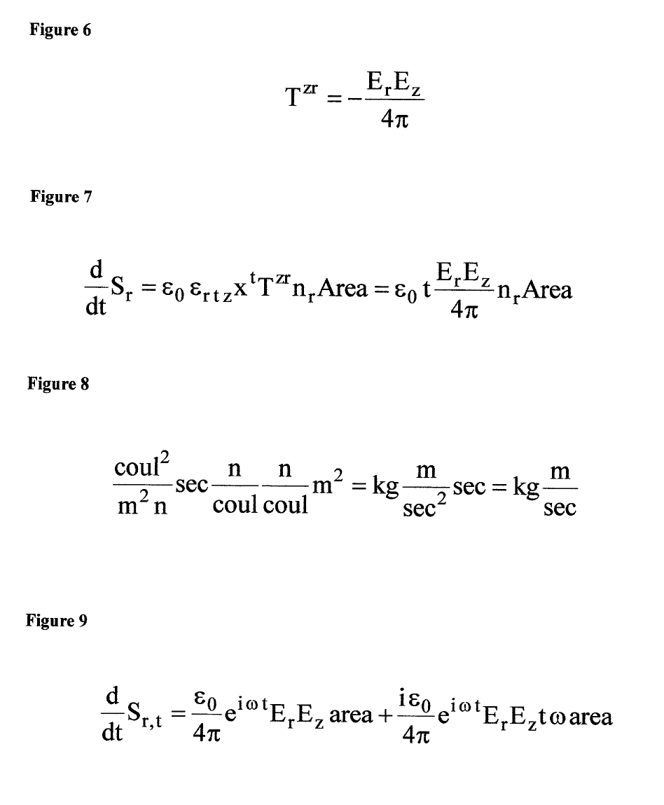

6. The radial electric Eᵣ field and the vertical electric E_{z} field can be inserted into the Faraday tensor seen in FIG. 5. The sign of the vertical field is positive because it points in the positive z-direction due to the fact that the annular ring has a negative charge. The cylinder has a positive charge. This produces the negative stress-energy tensor T^{zr} as drawn in FIG. 6.

7. In order to calculate the force on the cylinder, it is necessary to calculate the flow rate of angular momentum. Momentum is mass times velocity or mass meter per second. If the mass is moving in a circle, then there is a lever arm times the momentum which makes it mass meter squared per second. If this is differentiated with respect to time, then a flow rate of angular momentum is produced with units of mass meter squared per second squared. As mentioned previously, tensors have this dual nature where depending on the permutation of the variables, it means one thing or another. In this case, the lever arm will be time, rather than length which converts the flow rate of angular momentum into just linear momentum. If you change linear momentum with respect to time, then you get a force.

8. The flow rate of angular momentum S is shown in FIG. 7. The force has to be against the area whose normal vector is in the radial direction which is also the direction of the momentum. So S has an r subscript indicating that it flows in the radial direction. The permutation tensor ε has three subscripts which keeps track of the tensor notation. The first subscript is the same as the momentum subscript. Permutations of the coordinate variables which are in order have a plus one sign. Permutations which are in reverse order have a minus one sign. Permutations in which the variable are repeated are zero. For example, ε_{trθz}=−ε_{rtθz} because the r and t are in reverse order in cylindrical coordinates. Because the permutation tensor starts with r, then we can have permutations such as {r,t,z} which is a reverse order negative permutation. This negative sign cancels the negative sign of the stress tensor. The reason this permutation is chosen is because the first subscript on the stress-energy tensor is now z. Because the normal to the area is in the radial direction, then the stress-tensor matches the electric fields that we have available, which are also in the zr-direction.

9. In this case, the second subscript of the permutation tensor is time, rather than length. So the units become, as shown in FIG. 8, those of linear momentum. To me, this was very surprising. Then I realized that the radial electric field rotates with time which means the differential of the linear momentum produces a force on the hull. In exponential notation, the radial electric field rotates with Exp[iωt]. This is multiplied by the time lever arm, so the term that has to be differentiated is t e^{iωt}. The time lever arm saves the differentiation by making one term real so that the force is real. This is shown in FIG. 9. The units of the first term are real newtons. In the second term, the time t multiplied by the frequency cancels out in terms of units, so the units are still force, but imaginary

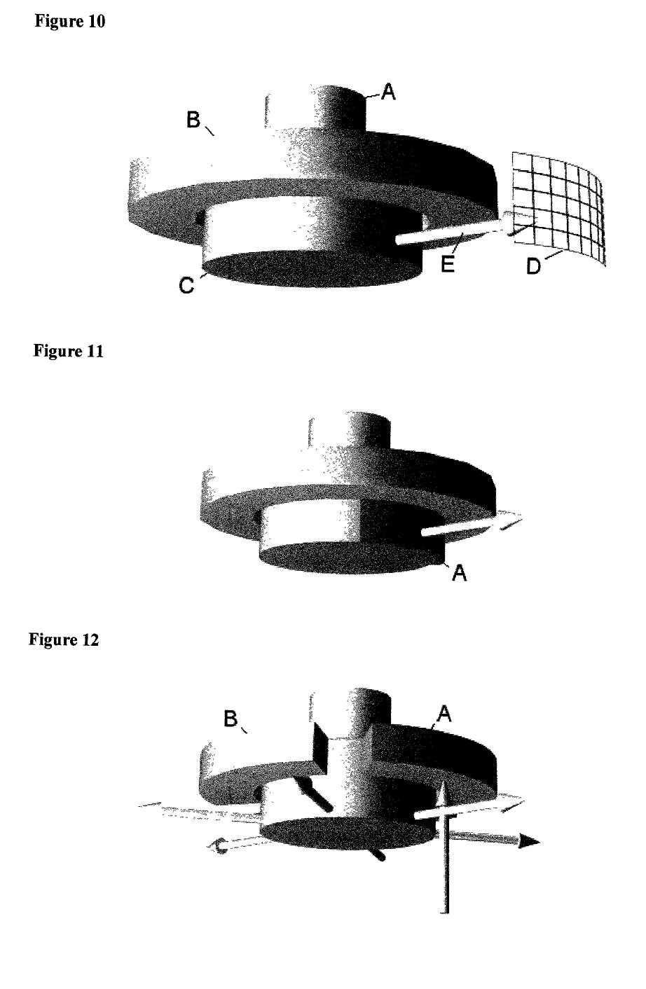

10. There is an area involved in the force equation which is depicted in FIG. 10. The charged rotating cylinder (C) located inside the charged annular ring (B) is driven by motor (A). The radial electric field (E) is normal to the area (D) whose normal vector is also in the radial direction. The angular momentum flows through this area which surrounds the cylinder. In doing so, it curves spacetime which produces the force.

11. If the radial electric field is continuous around the cylinder, then the net force is zero. Referring to FIG. 11, one section (A) of the rotating cylinder is charged, which means that there is a force once per cycle in a selected direction depending on when the annular ring is charged. The other option, referring to FIG. 12, is that the annular ring is divided up into two or three sections with the feature that the charge can be turned on (A) or off (B) on a particular segment. As the rotating electric field goes around, one of the annular ring sections will have an electric field in order create a force on that side.

12. Since there are three force cylinders, this allows for yaw motion control so that the hull of the spacecraft can pivot to change direction. After the directional change, the two back cylinders can be synchronized to produce thrust in the forward direction.

13. There could also be a polarity change for the vertical electric field such that a positive stress-energy is produced which would reverse the direction of the thrust.

What I claim as my invention is:

1. A spacecraft propulsion system utilizing three electrostatically charged motor-driven cylinders each one of which rotates within a charged annular ring to produce a spacetime stress curvature tension in the horizontal plane on the underside of the hull.

2. Said rotating cylinder comprised of bar magnets embedded in the cylinder and stacked in groups at intervals around the periphery of the cylinder with the purpose of increasing the permittivity of space by permeating the cylinder and ring with low linear mass, low speed of light hyperspace energy by means of a wormhole between our space and hyperspace. The larger permittivity is to increase the force. Said technique is contained in my patent applications Magnetic Vortex Wormhole Generator and Magnetic Vortex Generator.

3. Said rotating cylinder and annular ring having a suitable metal surface for forming and maintaining the electrostatic charge.

4. Said rotating cylinder having one or more segments which can be electrostatically charged individually or together to produce a force in a particular direction.

5. Said annular ring having one or more segments which can be electrostatically charged individually or together to produce a force in a particular direction.

6. A combination of three such thrusters providing a force in any particular direction or for yaw motion control.

7. Electric polarity switching of the fields in order to reverse the spacetime curvature and therefore change the direction of thrust.

8. The use of a magnetic vortex generator located above each thruster in order to permeate the cylinders and rings with low density hyperspace energy which would substitute for the embedded magnets in each cylinder.
